(19) United States
(12) Patent Application Publication
(10) Pub. No.: US 2006/0011442 A1
(43) Pub. Date: Jan. 19, 2006

(54) Hydraulic clutch

(75) Inventor: Kiyokazu Ichikawa, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: NSK-WARNER KABUSHIKI KAISHA

(21) Appl. No.: 10/892,480

(22) Filed: Jul. 16, 2004

(30) Foreign Application Priority Data
Jul. 16, 2004 (JP) P.2003-275076

(51) Int. Cl. F16D 25/0638

(52) U.S. Cl. 192/85 AA

(57) ABSTRACT

A hydraulic clutch has an operating hydraulic chamber, an operational member pushed in an axial direction thereof by a hydraulic fluid supplied from the operating hydraulic chamber so as to transmit torque by engaging frictional engaging elements, a non-operational member that defines the operating hydraulic chamber with the operational member, the non-operational member having a seal member setting portion thereon and a seal member provided in the seal member setting portion of the non-operational member. A bottom surface of the seal member setting portion is inclined so as to gradually shallow towards a direction that the operational member is pushed.

The present invention claims foreign priority to Japanese patent application No. JP.2003-275076, filed in the Japanese Patent Office on Jul. 16, 2003 the contents of which are incorporated herein by reference.

### BACKGROUND OF THE INVENTION

1. Field of the Invention

The present invention relates to a hydraulic clutch that is operated by hydraulic pressure.

2. Description of the Related Art

FIG. 5 shows a side-cross sectional view of a main structure of a hydraulic clutch 10. In FIG. 5, reference number 20 denotes a clutch case and reference number 30 denotes a piston. In FIG. 5, separate plates 41 are spline-engaged with a spline portion 21 of the clutch case, and friction plates 42 that are alternately interposed between the separate plates 41 are spline-engaged with a hub (not shown) to transmit a rotation thereof. Reference numbers 23 and 33 denote O-rings, reference numbers 52 and 53 denote seal members, and a line X-X denotes a rotation axis of the clutch.

When the clutch is operated, hydraulic fluid is supplied to a piston operating hydraulic chamber 47 via a hydraulic fluid supply path 51 of the shaft 50 and a hydraulic fluid supply path 24 of the clutch case 20 so as to press the piston 30 (i.e., move the piston 30 rightward in FIG. 5). Accordingly, a tip end portion 31 of the piston 30 pushes the separate plates 41 and the friction plates 42 towards a blocking ring 43, and then the clutch 10 is in an engaged state.

FIG. 4 shows a conventional structure of the O-ring 23 that is set on the clutch case 20 with respect to the piston 30. In FIG. 4, reference number 25 denotes a setting groove and reference number 26 denotes a bottom surface of the setting groove 25. In the conventional structure, the bottom surface 26 is formed so as to be parallel to a moving direction of the piston in its operation, as shown in FIG. 4.

When hydraulic pressure loaded on the piston 30 is released for releasing the engaging state of the hydraulic clutch 10, the piston 30 goes back to left side in FIG. 5 by a canceller 44 and a return spring 46, and the pressure loaded on the separate plates 41 and the friction plates 42 (i.e., the friction engaging elements) is released.

When the clutch is engaged, the hydraulic fluid enters into the groove 25 and in turn presses the O-ring 23 to right side in FIG. 5. When the clutch is released (i.e., disengaged), the pressure loaded on the O-ring 23 is reduced and the O-ring 23 expands. The O-ring 23 then pushes the bottom surface 26 and surrounding walls of the groove 25. The surrounding walls include the lower surface of the piston 30 and peripheral walls defining the groove 25. This expansion of the O-ring 23 generates a sliding resistance when the piston 30 starts its retreat (leftwards of FIG. 4), so as to release the engagement (i.e., disengage) of the clutch.

For promoting smooth releasing operation, it is necessary to reduce the sliding resistance caused by the expansion of the O-ring 23, which is in turn caused by the elastic force of the O-ring itself. However, the conventional clutch has a problem in that the sliding resistance is too high, thus resulting in the prevention of a smooth releasing operation.

### SUMMARY OF THE INVENTION

It is an object of the present invention to solve the above mentioned problem. The object can be achieved by a hydraulic clutch, comprising:
an operating hydraulic chamber;
an operational member pressed in an axial direction thereof by hydraulic fluid supplied from the operating hydraulic chamber so as to transmit torque by engaging a frictional engaging elements;
a non-operational member that forms the operating hydraulic chamber with respect to the operational member, the non-operational member having a seal member setting portion thereon; and
a seal member provided in the seal member setting portion of the non-operational member,
wherein a bottom surface of the seal member setting portion is inclined in a direction in which the operational member is pushed.

The above-mentioned hydraulic clutch according to the present invention, it is preferable that the bottom surface of the non-operational member is gradually inclined.

In addition, the above-mentioned hydraulic clutch according to the present invention, it is more preferable that an inclination angle of the inclined bottom surface of the non-operational member ranges from about 5 to 10 degrees with respect to the axial direction of the operational member.

Further, the above-mentioned hydraulic clutch according to the present invention, it is advantageous that the seal member is an O-ring.

Moreover, the above-mentioned hydraulic clutch according to the present invention, it is further advantageous that the hydraulic clutch is a wet type multiple disc clutch, the frictional engaging elements include a friction plate and a separate plate, the operational member is a piston of the wet type multiple disc clutch, and the non-operational member is a clutch case of the wet type multiple disc clutch.

### BRIEF DESCRIPTION OF THE DRAWINGS

FIG. 1 is a cross sectional view showing a main structure of the hydraulic clutch according to the present invention;

FIG. 2 is a cross sectional view showing an O-ring groove provided on the clutch case according to the present invention;

FIG. 3 is a cross sectional view showing a situation of the O-ring in operation of the clutch according to the present invention;

FIG. 4 is a cross sectional view showing a conventional O-ring groove; and

FIG. 5 is a cross sectional view showing a main structure of the conventional hydraulic clutch.

### DETAILED DESCRIPTION OF THE PREFERRED EMBODIMENTS

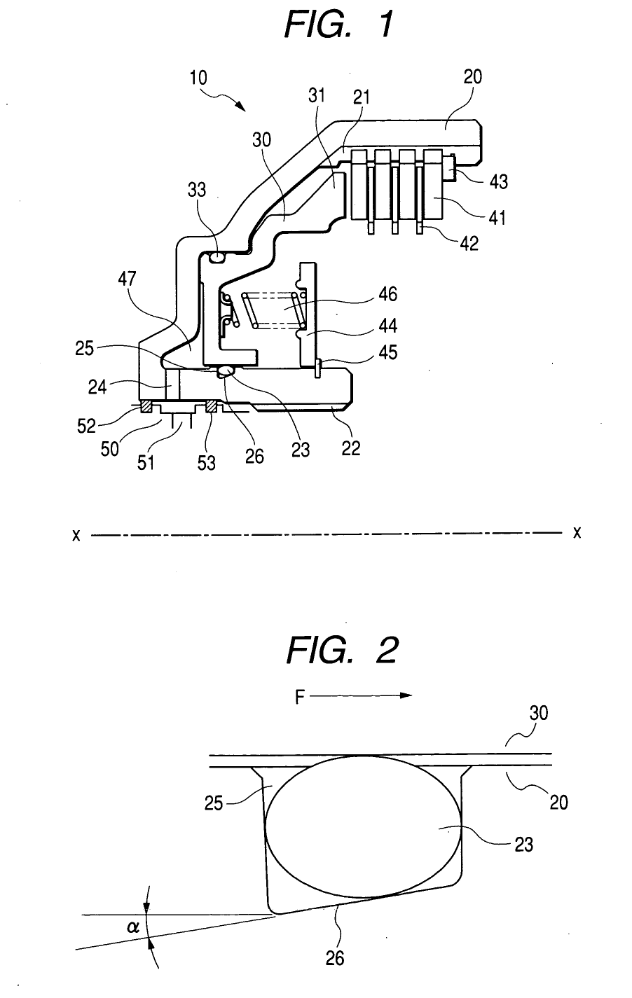

As an exemplary, non-limiting embodiment of the present invention, FIG. 1 shows a cross sectional view showing a main structure of a hydraulic clutch, such as a multiple disc clutch of wet type. FIG. 2 shows a setting state of an O-ring 23 of the clutch case 20 opposing the piston 30. In FIG. 2, the O-ring 23 is set in a setting groove 25 provided on the clutch case 20. Reference number 26 denotes a bottom surface of a groove 25. The bottom surface 26 is inclined from a deeper end in the direction opposite the friction plates 42, and sloping upward gradually in a direction toward the piston 30 (i.e., rightward in FIG. 2), so as to be shallower in the direction of operation of the piston 30 (arrow F) at the engaging portion of the clutch. An inclination angle α of the bottom surface is preferably ranging from about 5 to 10 degrees.

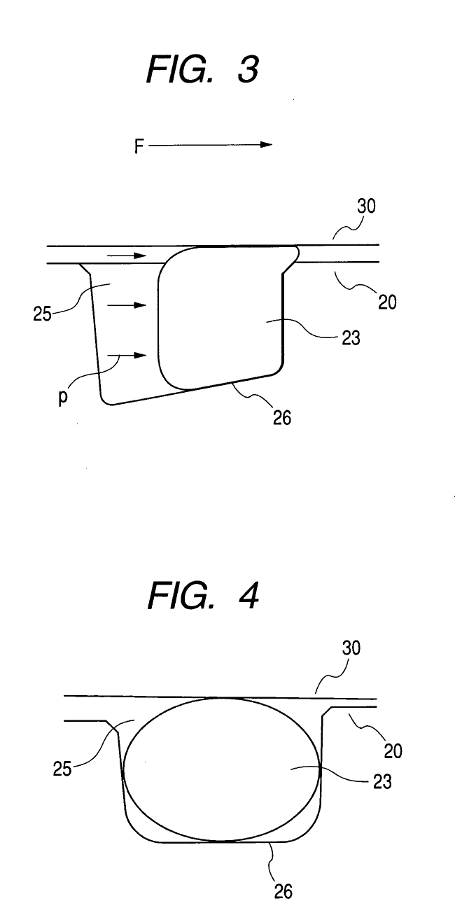

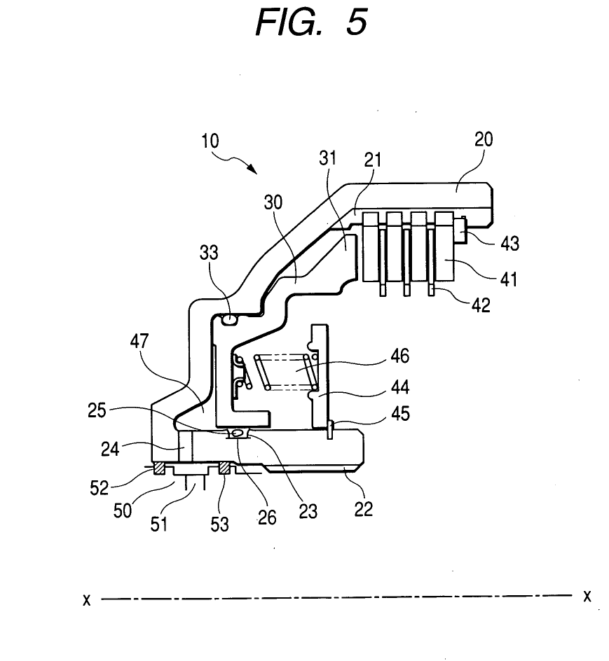

FIG. 3 is a drawing illustrating the position of the O-ring 23 in the setting groove 25 when the piston 30 moves forward to an operating direction thereof or when the clutch is engaged. The piston 30 is pushed to right side by hydraulic fluid in a piston operating hydraulic chamber 47 of FIG. 1, and the pressed hydraulic fluid enters the groove 25 via a gap between the clutch case 20 and the piston 30. As the hydraulic pressure indicated as small arrow p loads on the O-ring 23, the O-ring 23 is pressed into the right wall of the groove 25. Further, the O-ring 23 is elastically deformed and becomes in a state as emphasized in FIG. 3, and the O-ring 23 performs a sealing operation.

The hydraulic pressure is reduced when the clutch is released, the piston 30 tends to retreat to left side due to operation of a return spring 46, and hydraulic pressure p in the inner of groove 25 is reduced. Due to its elasticity, the O-ring 23 is able to return to its natural resting shape when there is no hydraulic pressure thereon. At that time, the O-ring 23 expands, tilting toward the left side in the groove 25 due to the friction between the piston 30 and the O-ring 23. That is, the O-ring 23 expands toward a deeper side of the groove 25, thus redeucing the sliding resistance between the piston 30 and the O-ring 23. Accordingly, the piston is capable of smoothly starting the releasing movement towards to left side in FIG. 3.

The foregoing description of the present invention is advantageous for at least the following reasons. Because (1) the hydraulic clutch of the present invention has the above-described structure, (2) the seal member setting portion is formed on the non-operational member, and (3) the bottom surface of the non-operational member is gradually shallow in the operational direction of the operational member, when the clutch is released, (1) the operational member retreats to the releasing direction, (2) the seal member expands to the deeper portion of the groove due to its elasticity, (3) the sliding resistance is reduced and (4) the operational member is capable of achieving smooth release operation not present in the conventional art.

While the foregoing has been described in connection with the exemplary, non-limiting embodiment of the present invention, it will be obvious to those skilled in the art that various changes and modification may be made therein without departing from the present invention, and it is aimed, therefore, to cover in the appended claim all such changes and modifications as fall within the true spirit and scope of the present invention.

1. A hydraulic clutch, comprising:
an operating hydraulic chamber;
an operational member pushed in an axial direction thereof by hydraulic fluid supplied from the operating hydraulic chamber so as to transmit torque by engaging frictional engaging elements;
a non-operational member that forms the operating hydraulic chamber with respect to the operational member, the non-operational member having a seal member setting portion thereon; and
a seal member provided in the seal member setting portion of the non-operational member,
where a bottom surface of the seal member setting portion is inclined in a direction in which the operational member is pushed.

2. The hydraulic clutch as set forth in claim 1, wherein the bottom surface of the non-operational member is gradually inclined.

3. The hydraulic clutch as set forth in claim 2, wherein an inclination angle of the inclined bottom surface of the non-operational member ranges from about 5 to 10 degrees with respect to the axial direction of the operational member.

4. The hydraulic clutch as set forth in claim 1, wherein the seal member is an O-ring.

5. The hydraulic clutch as set forth in claim 1, wherein the hydraulic clutch is a wet type multiple disc clutch, the frictional engaging elements include a friction plate and a separate plate, the operational member is a piston of the wet type multiple disc clutch, and the non-operational member is a clutch case of the wet type multiple disc clutch.
